(19) United States
(12) Patent Application Publication
(10) Pub. No.: US 2008/0282606 A1
(43) Pub. Date: Nov. 20, 2008

(54) SYSTEM AND PROCESS FOR PRODUCING BIODIESEL

(76) Inventors: John P. Plaza, Seattle, WA (US); Brian L. Goodall, La Jolla, CA (US)

Correspondence Address: STRATEGIC PATENTS P.C.., C/O PORTFOLIOIP, P.O. BOX 52050, MINNEAPOLIS, MN, 55402, US

(21) Appl. No.: 12/103,294

(22) Filed: Apr. 15, 2008

Related U.S. Application Data
(60) Provisional application No. 60/912,089, filed on Apr. 16, 2007.
(60) Provisional application No. 60/982,995, filed on Oct. 26, 2007.
(60) Provisional application No. 61/022,793, filed on Jan. 22, 2008.

(51) Int. Cl. C10L 1/18; B01J 19/18

(52) U.S. Cl. 44/308; 422/228

(57) ABSTRACT

In embodiments of the present invention, systems for producing a biodiesel product from multiple feedstocks may include a biodiesel reactor, a decanter, a flash evaporator and a distillation column. In other embodiments of the present invention, a process for producing a biodiesel comprises distilling a biodiesel reaction product to remove tocopherols and sterol glucosides and, optionally, adding biodiesel stabilizers to the resultant biodiesel to enhance thermal stability. The components of the system are interrelated so that parameters may be regulated to allow production of a custom biodiesel product.

### CROSS-REFERENCE TO RELATED APPLICATIONS

This application claims the benefit of the following provisional applications, each of which is hereby incorporated by reference in its entirety:

U.S. Provisional App. No. 60/912,089 filed Apr. 16, 2007; U.S. Provisional App. No. 60/982,995 filed Oct. 26, 2007; and U.S. Provisional App. No. 61/022,793 filed Jan. 22, 2008.

### BACKGROUND

1. Field

The present invention relates to a system and process for the production of biodiesel, recovery and removal of volatile components during biodiesel distillation, and the adjustment of the biodiesel with exogenous stabilizers.

2. Description of the Related Art

Biodiesel is a diesel-equivalent, processed fuel comprising alkyl esters made from the transesterification of any of a variety of feedstock oils. In the transesterification reaction, a triglyceride, which is an ester of free fatty acids, is reacted with an alcohol in the presence of a catalyst. The alcohol reacts with the fatty acids to form the mono-alkyl ester (or biodiesel) and crude glycerol.

Biodiesel is biodegradable and non-toxic, and has significantly fewer emissions than petroleum-based diesel when burned. Biodiesel may have a particular molecular weight, a particular distillation property, and the like. Biodiesel may be blended to obtain biodiesel blends useful for a variety of applications and industries. Biodiesel is compatible with petroleum products and infrastructure, such as pipelines, holding tanks, fuel lines, and burning capacity. In fact, one use of biodiesel is as an environmentally friendly, burnable, biodegradable cleaning agent for pipelines. With its pipeline compatibility, it may be possible to move the biodiesel product by pipeline in addition to barges and rail. Biodiesel is an excellent industrial solvent and degreasing agent. Placed into an old diesel engine, biodiesel tends to clean up the tank, remove deposits, and cleans out fuel lines, however, biodiesel does corrode and degrade natural rubber gasket and hoses.

Improvements to biodiesel production may be important to ensure the commercial success of biodiesel. For example, the efficiency of the biodiesel reaction under conditions of atmospheric pressure is suboptimal. As another example, centrifugation to remove the glycerin byproduct of biodiesel production interferes with overall process efficiency. As a further example, biodiesel polishing results in a burden of disposal of wash wastewater or spent magnesium silicate. Improvements that may overcome these shortcomings may enhance biodiesel production efficiencies to make the biodiesel production process and product more cost-effective.

There remains a need in the art for systems and processes for producing biodiesel fuel with near-simultaneous recovery of glycerin, methanol, catalyst, unreacted triglycerides, tocopherols, and the like. Moreover, there remains a need in the art for systems and processes for producing biodiesel with the production of minimal waste in the distillation step.

These and other systems, methods, objects, features, and advantages of the present invention will be apparent to those skilled in the art from the following detailed description of the preferred embodiment and the drawings.

### SUMMARY

Provided herein are systems and processes for producing biodiesel. These systems may comprise a biodiesel reactor. A biodiesel reactor according to these systems may comprise a housing enclosing a chamber for reaction of biodiesel precursor raw materials, an inlet in the housing for inflow of the raw materials, a stir bar anchored to an inner aspect of the housing bearing a plurality of stir paddles extending outwardly, a baffle partially segmenting the chamber into a plurality of mixing regions, and an outlet for outflow of reaction mixture. In some embodiments of the reactor, the stir bar is anchored centrally within the housing. In some embodiments of the reactor, the stir bar is oriented vertically within the housing. In some embodiments of the reactor, the stir paddles are attached to the stir bar at substantially right angles. In some embodiments of the reactor, the baffles are attached to the housing at an angle that is the same as the angle at which the stir paddles are attached to the stir bar. In some embodiments of the reactor, the reactor may further comprise a pressure and temperature controller.

In some embodiments, the reactor inlet is adapted for an inflow of a plurality of feedstocks. In some embodiments of the reactor, the biodiesel precursor raw materials comprise a feedstock oil, an alcohol, and a catalyst. In versions of this embodiment, the alcohol may be selected from the group consisting of methanol, ethanol, propanol and butanol. In versions of this embodiment, the catalyst may be selected from the group consisting of sodium methylate, sodium hydroxide, potassium hydroxide, sulfuric acid, vanadium-based catalysts, and the like. In versions of this embodiment, the feedstock oil may be selected from the group consisting of vegetable oil, fish oil, algae oil, rendered animal fats, used cooking oils, jatropha oil, and biomass conversion oils, and the like.

According to the methods disclosed herein, a process for producing a biodiesel may comprise selecting a feedstock oil, measuring an amount of an alcohol and catalyst to react with the feedstock oil, feeding the feedstock oil, alcohol and catalyst into a biodiesel reactor, reacting the feedstock oil, alcohol and catalyst in a plurality of mixing regions within the reactor to form a mixture, quenching the reaction within the reactor by adding a catalyst kill agent, decanting the mixture to separate biodiesel reaction product from byproducts including glycerin and excess alcohol, recovering excess alcohol by flash evaporation, burning the excess alcohol to provide energy for subsequent iterations of the biodiesel production process, and distilling the biodiesel reaction product in a distillation column to separate a plurality of biodiesels from the biodiesel reaction product. In examples of this process, additional steps may include reacting the biodiesel reaction product in a second reactor after the first decanting step, and decanting the mixture from the second reactor in a second decanter. In examples of this process, additional steps may include pressurizing the reactor. In examples of this process, additional steps may include controlling the temperature of the reactor. In examples of this process, additional steps may include separating heavy materials from the plurality of biodiesels in the distillation column.

The systems disclosed herein may comprise a biodiesel production unit. A biodiesel production unit may comprise a biodiesel process management facility comprising a feedstock selector for analyzing and selecting feedstock, a feedstock database containing feedstock parameters, a client database containing client specifications for biodiesel output, a reaction control facility for monitoring reaction parameters within the biodiesel production unit and for optimizing reaction parameters in accordance with feedstock parameters and client specifications. In embodiments, the biodiesel production unit may include at least one biodiesel reaction chamber comprising an impeller system for mixing biodiesel precursor raw materials, a first sensor system that identifies reaction parameters in the reaction chamber including temperature, pressure and impeller performance, at least one decanter for separating biodiesel reaction products from glycerin byproducts, a flash evaporation system for recovering alcohol from crude biodiesel and crude glycerin, a second sensor system that identifies reaction parameters in the flash evaporation system, a distillation column for separating biodiesel reaction products into a plurality of biodiesels, a third sensor system that identifies reaction parameters in the distillation column, and a biodiesel output analytics and management facility for analyzing characteristics of each biodiesel in the plurality of biodiesels. In embodiments, the biodiesel production unit includes a biodiesel product handling facility, comprising a product management facility, a storage system and a product outflow system, and a byproducts handling facility, comprising a byproducts recycling and utilization facility, a byproducts disposal facility, and a byproducts storage system. In some embodiments of the production unit, all components are contained within a single housing. In some embodiments of the production unit, the unit is sized to permit portability. In other embodiments, the biodiesel production unit comprises a plurality of biodiesel reaction chambers. In other embodiments of the production unit, the decanter comprises a centrifuge or a coalescer. In still other embodiments of the production unit, the production unit comprises a plurality of decanters.

The systems for producing biodiesel disclosed herein may comprise a biodiesel process management facility comprising a feedstock selector for analyzing and selecting feedstock, a feedstock database containing feedstock parameters, a client database containing client specifications for biodiesel output, and a reaction control facility for monitoring reaction parameters within the biodiesel production unit and for optimizing reaction parameters in accordance with feedstock parameters and client specifications. In embodiments, a system for producing biodiesel may include a biodiesel production unit for reacting feedstock to produce a biodiesel mixture, a separation facility for separating the biodiesel mixture from reaction byproducts, a distillation facility for distilling the biodiesel mixture into a plurality of biodiesel products, a biodiesel output analytics and management facility for analyzing characteristics of each biodiesel product, and a biodiesel product management facility comprising a product database containing product and blend specifications for each biodiesel product, and further comprising product management protocols. In embodiments, a system for producing biodiesel may further include a biodiesel storage and transport facility, permitting regulation of variables such as storage type, transport type, storage and transport conditions, and calculation of expiration date, and a temperature management facility for controlling the temperature within the storage and transport units. In some versions of the system, the reaction control facility may adjust parameters based on characteristics including feedstock type, alcohol type, catalyst type, amounts of raw materials, water content, sediment content, sulfur content, cetane number, pH, temperature, cost, and flash point. In some versions of the system, the biodiesel output analytics facility may perform one or more analyses, including gas chromatography, infrared spectroscopy, flash point analysis, water content analysis, sediment analysis, kinematic viscosity analysis, sulfur content analysis, copper strip corrosion analysis, cetane number analysis, cloud point analysis, conradson carbon residue analysis, distillation temperature analysis, lubricity analysis, microbial analysis, pH analysis, density analysis, and temperature analysis, and the like. In some versions of the system, the biodiesel output analytics facility may provide operational feedback to the biodiesel process management facility. As an example, the biodiesel process management facility may adjust reaction parameters based on the operational feedback, including such reaction parameters as temperature, reaction duration, raw material quantity, raw material type, stir speed, order and speed of raw material addition, and the like. In some versions of the system, the biodiesel output analytics facility may determine a downstream processing protocol for substances such as biodiesel, biodiesel blends, by-products, and recovered raw materials. In examples of this version, a downstream processing protocol may include techniques like separation, blending, additive addition, recycling, disposal, utilization, distillation, purification, and further reaction. In some versions of the system, the temperature management facility may regulate the temperature of chemical components situated in a biodiesel production vessel such as a biodiesel reaction chamber, a decanter, a flash evaporation system, a distillation column, a storage tank, a pipeline, a ship, a pump, and the like.

In an aspect of the invention, a process for producing a biodiesel may comprise reacting a feedstock oil, alcohol and catalyst to form a mixture of biodiesel reaction product and byproducts; quenching the reaction by adding a catalyst kill agent; decanting the mixture to separate biodiesel reaction product from byproducts, the byproducts comprising glycerin and excess alcohol; distilling the biodiesel reaction product in a distillation column to separate biodiesel from the biodiesel reaction product, recover tocopherols, and remove sterol glucosides from the biodiesel; and adding a biodiesel stabilizer to the biodiesel. The process may further comprise subjecting the biodiesel to a test of filter plugging tendency, comprising passing a sample of the biodiesel at a constant rate of flow through a glass fiber filter medium; monitoring the pressure drop across the filter during the passage of a fixed volume of the biodiesel; determining if a prescribed maximum pressure drop is reached before the total volume of biodiesel is filtered; and recording the actual volume of fuel filtered at the time of maximum pressure drop. In the process, the biodiesel fails the test if the maximum pressure is reached before the total volume of biodiesel is filtered. If the biodiesel does not pass the filter plugging tendency test, the biodiesel may be re-distilled. In the process, the biodiesel passes the test if the total volume of biodiesel is filtered before reaching the maximum pressure.

In an aspect of the invention, a process for obtaining a plurality of biodiesel output products may comprise producing a biodiesel reaction product stream; performing at least one vaporization-condensation cycle upon the biodiesel reaction product stream, thereby separating the biodiesel reaction product stream into a plurality of biodiesel output products, the products selected from the group consisting of impurities, industrial biodiesel, automotive biodiesel, bottoms, tocopherols, sterol glucosides, and catalyst.

In an aspect of the invention, a process for reducing the filter blocking tendency of biodiesel may comprise distilling a biodiesel reaction product to separate at least one of tocopherols and sterol glucosides from biodiesel. The process may further comprise adding a biodiesel stabilizer to enhance biodiesel stability.

In an aspect of the invention, a process for producing a biodiesel may comprise distilling a biodiesel reaction product to remove tocopherols and sterol glucosides; and adding biodiesel stabilizers to the resultant biodiesel to enhance thermal stability. In the process, the biodiesel may have significantly fewer emissions than petroleum-based diesel when burned. In the process, the biodiesel may be grade tailored by distillation. In the process, the tocopherols may be recovered as valuable by-products. In the process, the biodiesel may exhibit reduced filter clogging tendency.

In an aspect of the invention, a system and method for separating glycerin from a biodiesel reaction mixture may comprise transferring the biodiesel reaction mixture to a decanter; allowing the glycerin to settle out of the biodiesel reaction mixture; and monitoring the temperature and pressure of the contents of the decanter to maintain glycerin solubility. The system and method may include adding an anti-foam agent to prevent foaming of the glycerin. The system and method may include adding a catalyst kill agent to terminate the action of the catalyst. The catalyst kill agent may be carbon dioxide.

In an aspect of the invention, a system and method for preparing a glycerin by-product from a biodiesel reaction may comprise decanting glycerin from a biodiesel reaction mixture; mixing decanted glycerin with anti-foam agent; and subjecting decanted glycerin to flash evaporation to remove excess alcohol. The glycerin may be neutralized with sulfuric acid.

In an aspect of the invention, a system and method for an alcohol recovery system for a biodiesel production unit, comprising: an alcohol reboiler; and a liquid ring vacuum pump in fluid communication with an alcohol condenser and a non-condensable gas condenser.

In an aspect of the invention, a system and method for a split distillation column for separating a biodiesel reaction product into a set of biodiesels may comprise an inlet for the entry of the biodiesel reaction product into a distillation chamber within the distillation column; a reboiler in operative relation to the distillation chamber for heating the biodiesel reaction product in the distillation chamber to separate it into the set of biodiesels based on their volatility; a structured packing support surrounding both sides of the split distillation chamber to enhance the efficiency of the reboiler; a plurality of liquid collection areas arranged vertically within the distillation chamber to collect the components of the biodiesel reaction product at specified levels within the chamber, wherein the number of collection areas used for distillation may be dependent on the feedstock used to obtain the biodiesel; an outflow channel for each area to transport the biodiesel components to a collection manifold; and a liquid distributor in fluid communication with the collection manifold that separates the components into a set of biodiesels. Only a single biodiesel is collected when canola oil is the feedstock.

In an aspect of the invention, a system and method for preparing biodiesel may comprise forming a reactive mixture of a triglyceride with an alcohol and a catalyst, wherein the triglyceride comprises a feedstock selected from the group consisting of vegetable oil, animal fat, photosynthetic organism oil, waste type greases and combinations thereof; agitating the reactive mixture and controlling the reaction conditions so that transesterification takes place between the triglyceride and the alcohol; separating a transesterified reaction product for use as a biodiesel from reaction by-products; evaporating excess alcohol in a flash tank; terminating the action of the catalyst; and distilling the biodiesel to separate biodiesel streams and biodiesel by-products the biodiesel by volatility. In the system and method, the catalyst may be sodium methylate. In the system and method, the catalyst kill agent may be carbon dioxide. In an aspect of the invention, a product may be obtained by the process for preparing biodiesel.

In an aspect of the invention, a system and method for a transesterified biodiesel product may comprise a methyl ester with a gel point of at least 60° F.; wherein the product is substantially free of glycerin, catalyst, methanol, and free fatty acids, and wherein the product is also substantially free of sterol glucosides and tocopherols.

In an aspect of the invention, a system and method for a transesterified biodiesel product may comprise a methyl ester with a gel point of at most 35° F.; wherein the product is substantially free of glycerin, catalyst, methanol, and free fatty acids, and wherein the product is also substantially free of sterol glucosides and tocopherols.

In an aspect of the invention, a system and method for the preparation of biodiesel may comprise transesterification of a triglyceride in the presence of excess methanol and sodium methylate to form a mono-alkyl ester biodiesel; terminating the action of the catalyst using carbon dioxide; and distilling the biodiesel to separate biodiesel streams and biodiesel by-products by volatility. In an aspect of the invention, a product may be obtained by the process for preparing biodiesel.

In an aspect of the invention, a system and method for a financial product may comprise a contract having supply as a variable with greater influence than price, wherein the contract is on a biodiesel commodity.

### BRIEF DESCRIPTION OF THE FIGURES

The invention and the following detailed description of certain embodiments thereof may be understood by reference to the following figures:

FIG. 1 depicts a system and process for producing biodiesel.

FIG. 2 depicts a system of biodiesel reactors and decanters.

FIG. 3 depicts an exemplary biodiesel reactor.

FIG. 4 depicts a catalyst recovery system.

FIG. 5 depicts a flash evaporation system.

FIG. 6 depicts a distillation column.

FIG. 7 depicts a process flow diagram.

FIG. 8 depicts a process flow diagram.

### DETAILED DESCRIPTION

Disclosed herein are systems and methods directed to a biodiesel production process that may be a fully controlled, multi-stage, monitored, continuous process. In an embodiment, the total residence time of the biodiesel process may be approximately two hours. The major stages of an exemplary biodiesel production process may include biodiesel precursor materials input, biodiesel reaction, glycerin separation, alcohol recovery, biodiesel distillation or polishing, by-products recovery, transportation and logistics, and in embodiments, biodiesel blends. In general, the biodiesel reaction involves the mixture of an alcohol with a triglyceride in the presence of a catalyst to generate methyl esters (biodiesel), glycerin, and other biodiesel by-products (“bottoms”). To force the biodiesel reaction to completion, an excess amount of alcohol may be used. In general, downstream processing of the biodiesel may include excess methanol removal and recovery, catalyst kill and recovery, biodiesel distillation, bottoms recovery, and glycerin recovery.

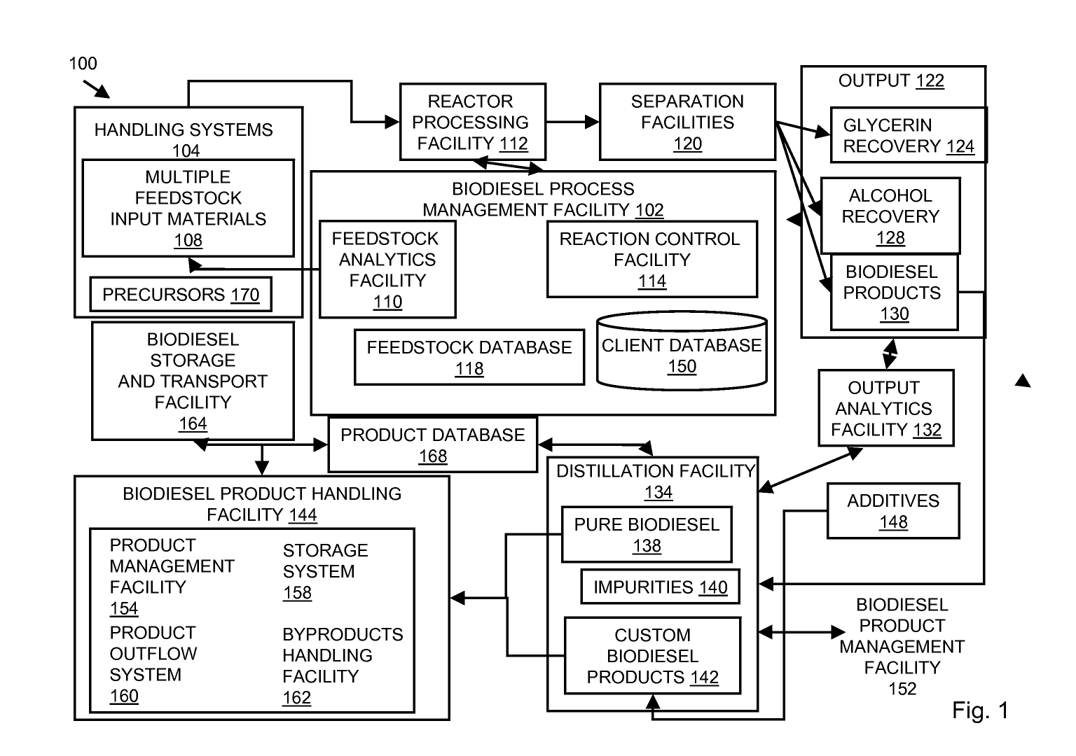

FIG. 1 depicts generally a system 100 for the production of biodiesel fuel products. As shown in FIG. 1, handling systems 104 are available to process multiple feedstock input materials 108 in communication with a feedstocks analytics facility 110. In the depicted embodiment, feedstock input materials 108 may be fed into the reactor processing facility 112, the parameters of which may be optimized by an IT architecture system, such as a Distributed Control System (DCS). In embodiments, the IT architecture interfaces with a biodiesel process management facility 102. The biodiesel process management facility 102 may control a reaction control facility 114 and a feedstock analytics facility 110. The biodiesel process management facility 102 may access information regarding client preferences and feedstock stored in a client database 150 and a feedstock database 118. In embodiments, the IT architecture interfaces with the biodiesel production system 100, a separation facility 120, a distillation facility 134, a biodiesel output analytics and management facility 132, a product database 168, a biodiesel product handling facility 144, a biodiesel storage and transport facility 164, and the like. As depicted in FIG. 1, the feedstock input materials 108 may be processed in the optimized reactor processing facility 112 to yield an output stream that provides the substrate for the separation facilities 120. The separation facilities 120 may include, without limitation, decanters, settling tanks, centrifuges, and coalescing filters, as is described in more detail below. The separation facilities 120 may yield a plurality of output products 122, including for example glycerin 124, alcohol 128 and biodiesel products 130 and by-products, unreacted triglycerides, unreacted catalyst, and the like, as illustrated by FIG. 1. The glycerin 124 and the alcohol 128 may be recovered, and the biodiesel products 130 may be processed further. As shown in FIG. 1, the biodiesel products 130 may be subjected to distillation or biodiesel polishing 134, a process by which pure biodiesel 138 may be separated from impurities 140, or biodiesel products may be combined with additives 148, anti-oxidants, stabilizers, or the like. The substances resulting from distillation may be separated, collected and stored, for example in the product handling facility 144 as shown in FIG. 1. The biodiesel product handling facility 144 may control product management 154, product outflow 160 and storage 158, and by-product handling 162. Biodiesel products resulting from the separation technologies 120 may be analyzed, with the results stored in the output analytics facility 152 and compared with product specifications 168 provided, for example, by a biodiesel customer. Product specifications 168 may also allow custom formulation of custom biodiesel products 142, for example by combining a biodiesel product 130 or 138 with a specific additive 148 or set of additives, petroleum diesel, stabilizers, and the like to attain desired characteristics.

With reference to FIG. 1, biodiesel precursor materials 170 may comprise a plurality of chemical components, including feedstock oil, catalyst and alcohol which react together to produce biodiesel. A biodiesel production facility may be designed to accommodate a variety of oil feedstocks in the manufacture of the end-product. For example, a vegetable oil may be used, but other starting materials may be used satisfactorily, as would be appreciated by practitioners of ordinary skill. For instance, genetically modified crops may prove to be a high yield source of feedstock oil. The development of energy specific crops allows for manipulation of the resultant oil to produce characteristics favorable to biodiesel production without having to cater to the needs of the edible oil industry. Feedstock oils may be obtained with an increase in the finished methyl ester degree of unsaturation and at a more consistent distribution of desirable ester chain lengths. The new crops will produce a higher yield, the actual oilseed will have a higher oil content, and the resultant biodiesel will be of a higher, more uniformed quality. In embodiments, the harvested oil to be used for biodiesel feedstock may be obtained at a higher yield to allow for production of higher quality biodiesel with a concomitant reduction in by-product and waste In other embodiments, it may be possible to obtain value-added meal from the seed with the potential for output of ethanol and other alcohols, natural bio-herbicides and pesticides as well as for its traditional use in the animal feed industry.

Other feedstock oils may be used in the manufacture of biodiesel according to these systems and methods, including one or more of vegetable oil, fish oil, algae oil, rendered animal fats, used cooking oils, jatropha oil, biomass conversion oils, oil miscella, hydrogenated oils, derivatives of the oils, fractions of the oils, conjugated derivatives of the oils, any mixtures thereof, and the like. Examples of vegetable oil include rapeseed, canola, soybean, palm, mustard, nasturtium seed, hemp, castor, coconut, corn, cottonseed, false flax, peanut, radish, ramtil, rice bran, safflower, sunflower, tung, honge, jojoba, milk bush, petroleum nut, olive oil, sesame oil, palm kernel oil, low erucic acid rapeseed oil, lupin oil, evening primrose oil, sorghum, eucalyptus, groundnuts, pumpkin seeds, and the like. Examples of animal fats include tallow, lard, yellow grease, chicken fat, dairy butterfat, and the like.

Selecting a feedstock oil may be informed by a number of factors. For example, the use of a non-edible oil such as that derived from the jatropha seed may be advantageous to counter the political “food versus fuel” dilemma. In another example, while an oil such as palm oil may result in the greatest yield of industrial grade biodiesel which can replace some of the most polluting forms of traditional diesel such as #6 diesel, it poses temperature management problems. In another example, algae may be further modified to obtain high-lipid content strains that produce oils with ideal biodiesel characteristics, such as C18-unsaturated, canola-like oils, a modification which may be pivotal given algae's high yield capacity (˜10,000-20,000 gallon/acre yield) using only CO₂ and NOx waste gases from industrial exhaust stacks for nourishment. The potential is two-fold, oil production in quantities that would allow biodiesel to effectively replace petroleum based diesel, and the potential to recoup massive amounts of carbon off-set credits.

Additional biodiesel precursor materials 170 useful in biodiesel production may include an alcohol. Co-location and co-generation with ethanol fuel production facilities may result in greater efficiencies in terms of energy, utilities, and logistics and may facilitate the use of ethanol in biodiesel production. Examples of alcohols include ethanol, methanol, and the like.

Additional biodiesel precursor materials 170 useful in biodiesel production may include a catalyst. Examples of catalysts may be sodium methylate, sodium hydroxide, potassium hydroxide, sulfuric acid, vanadium-based catalysts, other solid-state catalysts, and the like. Catalyst may be produced on-site. An example of a solid-state catalyst is a vanadium catalyst which may be plated on a silica resin where non-aqueous acid quench may be employed. Solid state catalysts are not suspended in the solution but instead are integrated directly into the design of the reactor vessels. As feedstock oil and alcohol passes over the fixed bed catalyst, the transesterification reaction may be initiated. Use of a solid-state catalyst may permit use of alternate reactor designs, such as but not limited to, fluidized bed, other structured beds, microchannel reactors, and the like. Replacing sodium methylate may reduce production costs, simplify the process flow, and reduce residence time by creating a more immediate and complete reaction. The by-product of biodiesel production, glycerin, may be produced with a higher purity because of the lack of sodium in solid-state catalyst. This increased purity may increase the value of the glycerin. The biodiesel itself may also be cleaner because of reduced soap formation when using solid-state catalysts, again reducing time and costs by cutting down on the need to further purify the biodiesel. Limitations on the use of solid catalysts include: the potentially high methanol/oil ratio, high required reaction pressure, high required reaction temperature, reactor physical design, high installed cost, and limited longevity. Use of a microchannel reactor may help to overcome these some of these limitations.

As depicted in FIG. 1, multiple feedstock input materials 108 such as those described above pass into the handling system 104 of the biodiesel production system 100. Raw feedstock oil may be transported to the handling system 104 via rail, ship, and the like. The handling system 104 may be located near ports to facilitate receipt of raw feedstock oil and delivery of biodiesel products. Handling of the raw feedstock oil may be facilitated by load/unload infrastructure, such as and without limitation, prewired hoses and easily accessible tanks that are primed to receive oil, which ensures rapid and efficient dock operations thereby lowering port costs and preventing demurrage charges. Receipt of raw feedstock oil may involve heated transport to and from heat barges. Receipt of raw feedstock oil may involve controlling both deep-draft ship berths as well as barge specific piers. The pipelines running to and from the piers may be heat-traced and insulated allowing for the delivery of any feedstock available regardless of cold flow properties.

Feedstock oils may be advantageously co-mingled in storage tanks upon delivery at pre-determined ratios in order to produce finished biodiesel with specific operating parameters. For instance, palm oil and soybean oil may be mixed together for storage in differing ratios during storage and eventually produced into biodiesel. In an embodiment, the ratio may be 3:1. Using the same ability to blend in specific ratios within the storage tanks, finished biodiesel may be similarly blended from different feedstocks to create boutique fuels.

A variety of factors may affect the quantity of useful raw material that is needed and the quantity of end-products obtained as output from the biodiesel production system 100. Factors may include the co-mingling of feedstock oils and the ability to accurately track the co-mingling ratios. Properties related to the oxidative stability, the degree of oil saturation, and the cold flow characteristics can be manipulated through proper mixing of feedstocks and finished products. Factors relating to oxidative stability, such as fatty acid composition and iodine value, may be assessed and adjusted at any point in the process, advantageously as the vessels are loaded with feedstock oil, through in-line testing and additive injection. Proper blending of feedstock may result in favorable percentages of specific fatty acid ester chain lengths. In certain embodiments, the degree of oil unsaturation may be high to obtain oils with lower freezing point temperatures. To achieve unsaturation, modification of feedstock oils, such as soybean and palm oil, in a process that may be described as the opposite of hydrocracking results in oils with higher degrees of unsaturation. Such a process can be used to generate unsaturated oils from a variety of raw feedstock oils. In another example, to meet the challenge of handling and blending high viscosity oils in differing temperature conditions, the storage facilities and piping are heated, insulated, and agitated to ensure oils do not freeze or gel.

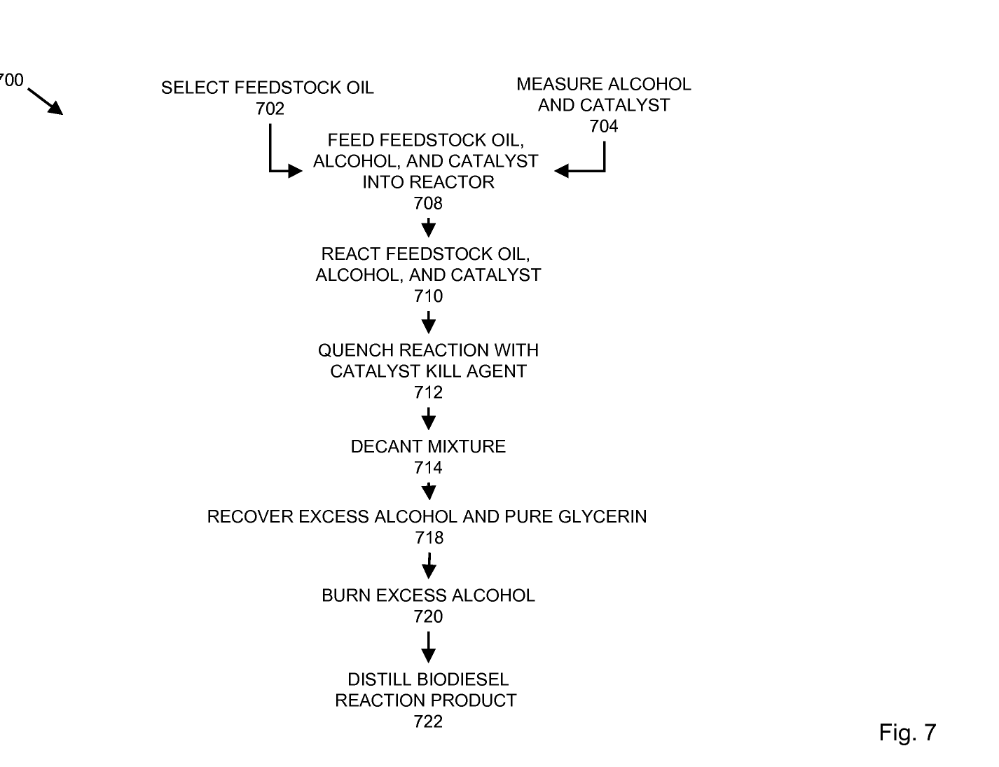

With reference to FIG. 7, a biodiesel process 700 may involve selecting a feedstock oil 702, measuring alcohol and a catalyst 704, feeding the feedstock oil, alcohol, and catalyst into a reactor 708, reacting the feedstock oil, alcohol, and catalyst 710, quenching the reaction with a catalyst kill agent 712, decanting the reaction mixture 714, recovering excess alcohol 718 and pure glycerin, burning excess alcohol 720, and distilling the biodiesel reaction product 722. Optionally, biodiesel stabilizers may be added to the biodiesel produced after distilling the biodiesel reaction product.

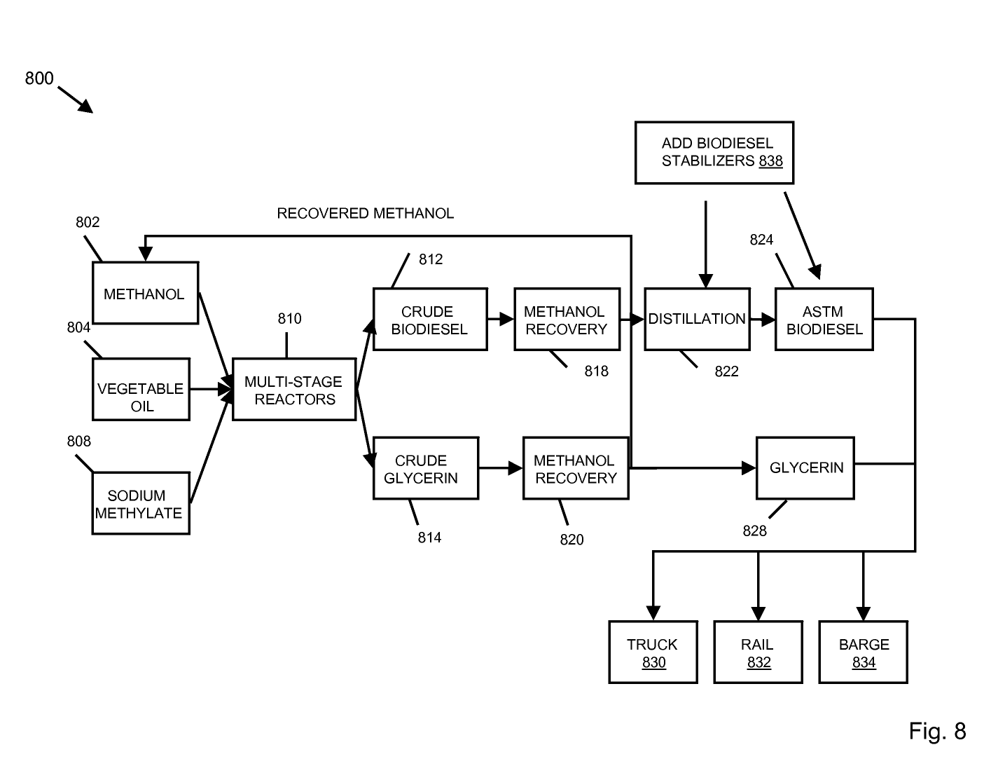

Referring to FIG. 8, another embodiment of a process 800 for biodiesel production may involve methanol 802, vegetable oil 804, and sodium methylate 808 being introduced into multi-stage reactors 810. A biodiesel reaction may take place in the multi-stage reactors 810 to produce crude biodiesel 812 and crude glycerin 814. The crude glycerin 814 may undergo methanol recovery 820 to extract methanol and pure glycerin 828. The glycerin 828 may be transported by trucks 830, rail 832, and barge 834. The recovered methanol may be fed back in the multi-stage reactors 810 as starting material for the biodiesel reaction. The crude biodiesel 812 may undergo methanol recovery 818. The recovered methanol may be fed back in the multi-stage reactors 810 as starting material for the biodiesel reaction. The crude biodiesel 812 may undergo distillation 822 to provide ASTM biodiesel 824. ASTM biodiesel 824 may be transported by trucks 830, rail 832, and barge 834. Biodiesel stabilizers 838 may be added after distillation 822 or as biodiesel 824 is stored or transported.

The biodiesel process 700, 800 may be controlled by a biodiesel process management facility 102. A biodiesel process management facility 102 may comprise a feedstock analytics facility 110 for analyzing and selecting feedstock, a feedstock database containing feedstock parameters 118, a client database containing client specifications for biodiesel output 150, and a reaction control facility 114 for monitoring reaction parameters within the biodiesel production unit and for optimizing reaction parameters in accordance with feedstock parameters and client specifications.

The feedstock analytics facility 110 may facilitate analysis of and selection of raw feedstock oil for the biodiesel process. Feedstock may be analyzed for a variety of properties, such as water content, sediment content, acid and free fatty acid (FFA) content, carbon chain length, the degree of saturation within the tri-glyceride molecule, sulfur content, cetane number, pH, temperature, flash point, and the like. For example, free fatty acid contents that are low result in the need for less methanol and catalyst input which results in lower cost processing of ASTM standard biodiesel. If the free fatty acid, water, or sediment content of the feedstock oil are unsatisfactory, the raw feedstock oil may require further treatment or adjustments to the process, such as changes to the reactor feed rates or additional biodiesel polishing. Such adjustments may include adjustments to the reaction or distillation parameters in order to ensure biodiesel product quality. For example and without limitation, for extremely high free fatty acid content oils, an additional process step called esterification may be employed. Though an increased cost may be borne during production, this may be offset by drastically reduced feedstock cost due to its low quality. In another example, if the water content of the feedstock is high, additional heat energy may be added to the system to evaporate water. Additional energy inputs used in treating the feedstock can be tracked and the entire process can be adjusted to maximize this extra energy input. In addition to a raw oil heater prior to the reactor, the levels of catalyst and methanol injected into the reactor may be adjusted to maximize yields in accordance with the feedstock's specifications. In another example, sediment may be allowed to phase separate from the glycerin thus obviating low micron filters. Most sediment in less processed oils may end up in the glycerin after phase separation and, once the glycerin is burnt, may end up as ash in the boiler. This advancement in the processing technology may allow acceptance of cargoes of off-specification feedstocks.

Analytical measurements of feedstock oils may be stored in a feedstock database 118. Selection of feedstock oil may be based on an end-user need, an end-user specification, an end-use application, a cost limitation, a quality limitation, a supply, a demand, and the like. For example, a non-palm oil feedstock may be selected for a client desiring a biodiesel suitable for cold weather applications. Residence time in the reactor may be controlled, monitored, and adjusted by the reaction control facility 114. A client database 150 containing client specifications for biodiesel output may be accessed in order to determine the amount and type of biodiesel precursor raw materials to mix. A reaction control facility 114 may monitor reaction parameters within the biodiesel production unit and optimize reaction parameters in accordance with feedstock parameters 118 and client specifications 150.

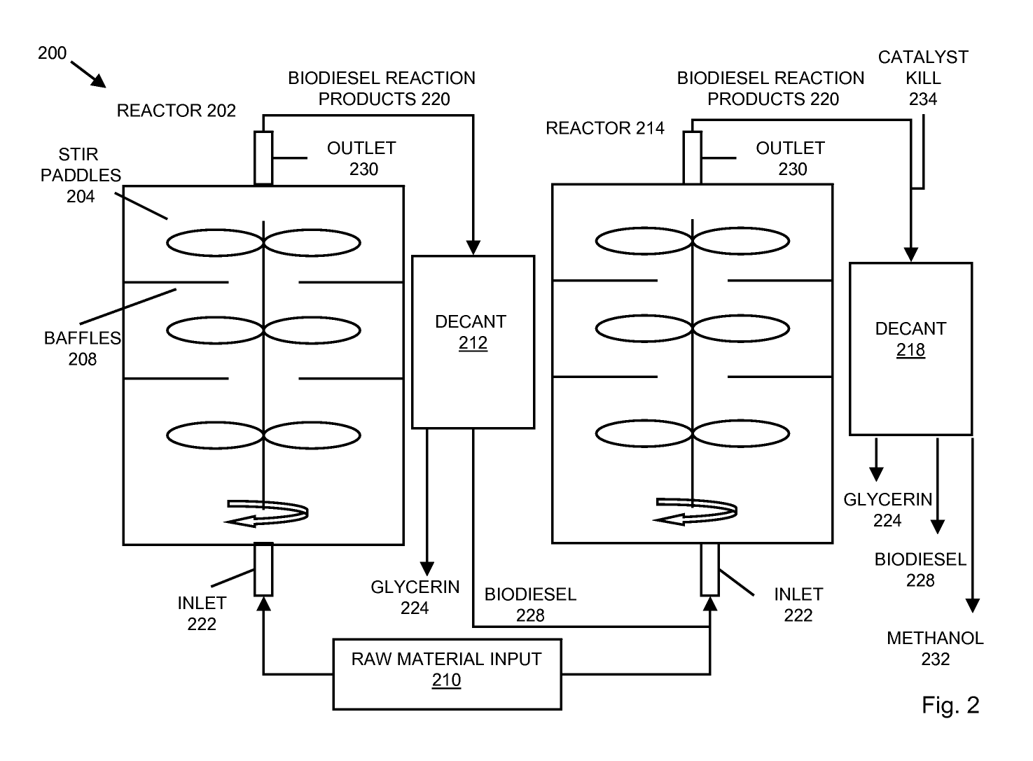

FIG. 2 depicts an embodiment of a biodiesel reactor system. The reactor may be a multi-stage, agitated tank reactor. The reactor may be an ultra efficient pressurized pulse reactor. The reactor may be pressurized and may have internal baffles and spray nozzles which ensure constant and consistent blending of the feedstock, alcohol and catalyst. The reactor, and other components of the biodiesel production unit, may be operated under nitrogen in order to keep oxygen out of the system. The reactor may lack vapor space so the alcohol may be forced into contact with the oil to aid in reaction efficiency. Oil, alcohol, and the catalyst may be fed into the reactor and forced to perform the multi-stage reaction in a series of turbulent zones created by in-line static mixers. Multiple reactors may be easily installed to increase reaction residence time and production rate. The reaction control facility 114 determines optimum levels of methanol and catalyst to be added during both the first and the second reaction leaving the original ratio of feedstock, methanol and catalyst intact while allowing for maximum reaction efficiency. The reactors may be low maintenance, have minimal moving parts, and may be easily cleaned.

In the depicted embodiment, there may be two reactors, a first reactor 202 and a second reactor 214. Raw material 210 enters each reactor 202 and 214. As shown in FIG. 2, raw input material may enter the first reactor 202 where it is agitated by a series of impellers 204 in layers separated by baffles 208. Biodiesel reaction products 220 from the first reactor may flow into a first decanting chamber 212, where biodiesel reaction products 220 are separated from glycerin 224 and pass into the second reactor 214. The biodiesel reaction products 220 may be combined with a stream of raw material input 210 as shown in the Figure. Materials entering the second reactor 214 undergo the same reaction as has taken place in the first reactor 202. The reactors may be versatile—the same reactor may be used in both reactor stages with slight changes in operating conditions to account for the decanted glycerin. Biodiesel reaction products 220 from the second reactor pass into the second decanting chamber 218, where biodiesel 228 is separated from any residual glycerin 224.

With reference to FIG. 2, and in more detail, a plurality of reactors may be employed in biodiesel production. Additional reactors may facilitate reaction completion after the separation of biodiesel by-products. Additional reactors may also ensure system redundancy so that biodiesel production may proceed continuously. The plurality of reactors may all be of the same design or may be of different designs. In embodiments, the biodiesel reaction proceeds in a first reactor 202 followed by a decanting step to remove glycerin by-products 224. The biodiesel reaction product 220 may be removed from the first reactor 202 through an outlet 230 for outflow of the reaction product. The decanting step may provide for removal of about 98% of glycerin 224. Then, the biodiesel reaction product 220 may be introduced into a second biodiesel reactor 214 through an inlet 222 for inflow of reaction mixture, optionally with additional biodiesel precursor raw materials 210, to complete the biodiesel reaction. The reaction parameters in the second biodiesel reactor 214 may be modified to account for the changes in chemical composition of the biodiesel reaction mixture. A second decanting step may remove additional glycerin by-product.

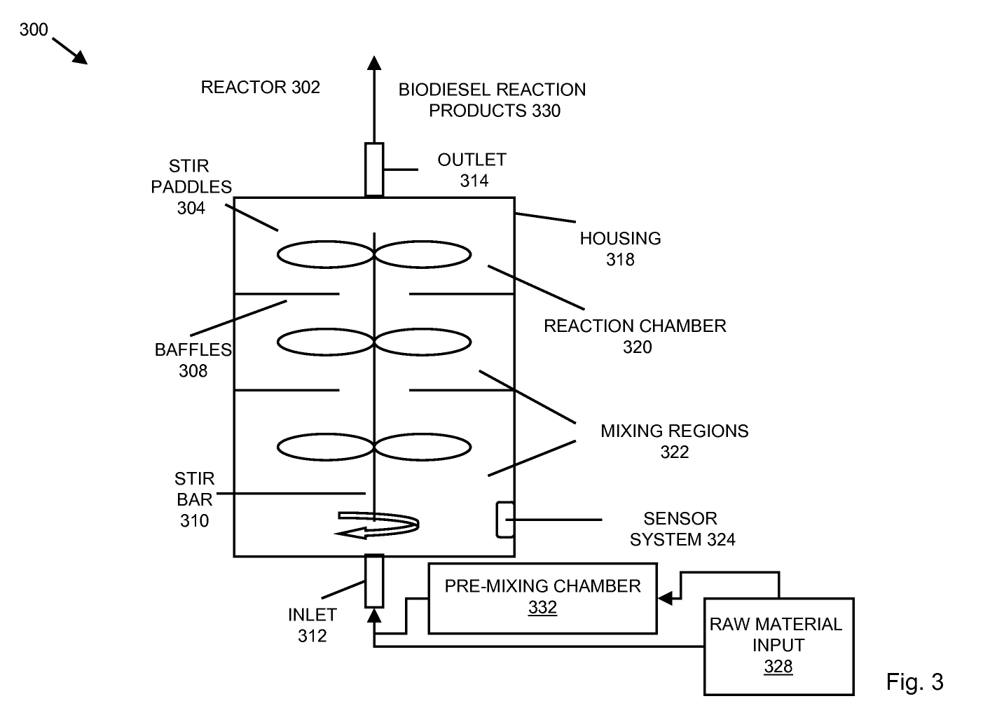

Referring in more detail to FIG. 3, the biodiesel reactor may comprise a housing 318 enclosing a chamber 320 for reaction of biodiesel precursor raw materials 328, an inlet 312 in the housing 318 for inflow of the raw materials 328, a stir bar 310 anchored to an inner aspect of the housing 318 bearing a plurality of stir paddles 304, or impellers, extending outwardly, at least one baffle 308 partially segmenting the chamber 320 into a plurality of mixing regions 322 wherein mixing may result in a turbulence, and an outlet 314 for the outflow of reaction mixture, including biodiesel reaction product 330 and by-products. Biodiesel precursor raw materials 328 may be mixed in a premixing chamber 332 prior to addition to the biodiesel reactor 302. Alternatively, the biodiesel precursor materials 328 may be added to the biodiesel reactor 302 separately through a single inlet 222 or multiple inlets. The reactor may be adapted for use with multiple feedstock oils which may be co-mingled. The absence of vapor space in the top of the biodiesel reactor may keep the alcohol dissolved in the reaction mixture to facilitate driving the reaction to completion. The pressure created by the introduction of the feedstock, methanol and catalyst streams, on the order of about 100 psi or 6-7 atm, may be sufficient to maintain the reactor at a pressure sufficient to perpetuate the reaction and to maintain the solubility of the alcohol at operating temperatures. The continuous application of heat and pressure prevent reversion and ensure product quality.

The physical design of the biodiesel reactor 302 may include “pushing bottom” and “pulling top” that facilitates pulling out the methanol from any vapor space in the top of the reactor and prevents methanol vapor accumulation, thus increasing safety. The design may ensure that alcohol amounts in the reactor are kept at a safe level. A sensor system 324 may be deployed within the reactor 302 to identify reaction parameters, such as pressure, temperature, impeller performance, and the like. For example, excess methanol may be metered to the biodiesel reactor 302 to ensure complete conversion of the oil to methyl esters. In another example, the amount of catalyst may also be metered and controlled to allow the reaction to go to completion and to prevent soap-producing side reactions. Thus, production rates and quality may be under tight control and constantly monitored both electronically and through in-house lab analysis. Desired daily production levels may be programmed and controlled by the facilities control system and the reactor may adjust automatically to the pre-set production levels.

Biodiesel specifications, output rates, production levels, and the like may be controlled by adjustments to the amounts of biodiesel precursor raw materials 328, the pressure of the reaction, and the temperature of the reaction by a reaction control facility 114. As an example, a client may request that only a small quantity of a particular biodiesel be produced for use as a test batch. The reaction control facility 114 may thereupon adjust the amounts of biodiesel precursor raw materials 328 according to these client needs. Alternatively, a biodiesel reactor 302 may be completely filled with biodiesel precursor raw materials 328 and the reaction control facility 114 will adjust the parameters of the reaction to ensure a preset production level. The reaction control facility may employ Distributed Control System (DCS) control programming logic and instrumentation to provide for a tightly controlled and monitored biodiesel process.

The first step in the biodiesel process may be the pre-heating of the raw materials 328. The raw feedstock may be pre-heated by at least one of a thermal fluid heater or a heat exchanger. The thermal fluid heater, which may be fired by natural gas, biodiesel, or any other fuel source, may provide a source of heat to pre-heat the raw materials 328 as well as provide heat to any other step in the process or to the storage tanks in order to provide freeze protection. In an alternative embodiment, if the process is already running and generating heat, waste heat from the process may be recovered and used in a heat exchanger to warm the raw materials. For example, one or more shell and tube heat exchangers may be used where the outbound materials from the process, such as hot biodiesel, are cooled on one side of the exchanger while exchanging heat with raw feedstock materials on the other side of the heat exchanger. Exchange may continue until the raw feedstock reaches a pre-determined temperature, such as 210° F.

To remove excess water from the raw feedstock, the feedstock may be sent to a raw oil dryer. In the raw oil dryer, atmospheric air is blown over the surface of recirculating feedstock in order to drive off and discharge water. At this point, the raw feedstock may be stored in a raw oil surge tank or it may immediately enter the biodiesel reactor and begin the biodiesel production process.

The reaction control facility 114 may regulate the temperature within the biodiesel reactor 302. As used herein, the term “regulating” may include monitoring or adjusting. The reactor operating temperature may be controlled to avoid degradation of raw material or biodiesel when the temperature is too high and to avoid poor reaction efficiency when the temperature is too low. Other reaction parameters that may be monitored and/or regulated include pressure, tail end measures, quality measurements, density of the materials between the two reactors or within a process vessel, temperature degradation versus reaction completion, turbulence, shear, flow rate, feed rate, and the like.

The feedstock oil, alcohol, and catalyst may enter the biodiesel reactor through an inlet which may be situated at the bottom of the tank and the raw materials may be mixed inside a biodiesel reaction chamber 320 by a plurality of stir paddles 304 extending outwardly from a stir bar 310 anchored to an inner aspect of the biodiesel reactor 302 housing 318. The stir paddles 304 and stir bar 310 may provide high shear within the biodiesel reaction chamber 320 and cause the materials to progress vertically through the tank. The stir bar 310 may be anchored to a central aspect of the housing or to a wall of the housing. Alternatively, the stir bar 310 may be anchored magnetically to the housing 318. In embodiments, multiple stir bar 310 and stir paddle 304 assemblies may be disposed within the reaction chamber 320 wherein their placement in the reaction chamber 320 may be controlled by an applied magnetic field. The stir bar 310 may be oriented vertically within the housing 318. The stir paddles 304 may be attached to the stir bar 310 at substantially right angles. Alternatively, the angle of the stir paddles 304 with respect to the stir bar 310 may be adjusted. In some embodiments, the angle may be 0° and the stir paddles 304 may be folded such that they are parallel to the stir bar. Baffles 308 may partially segment the chamber 320 into a plurality of mixing regions 322. The baffles 308 may be attached to the housing 318 at an angle that is the same as the angle at which the stir paddles 304 are attached to the stir bar 310. The angulation of the stir paddles 304 and the baffles 308 may be fixed for a particular reactor 302. In embodiments, the angulation of the stir paddles 304 and/or baffles 308 and speed of agitation may be adjustable to create mixing regions 322 with specific properties. Mixing regions 322 are understood to be sub-areas within the chamber 320 where a volume of the biodiesel reaction mixture is agitated by a stir paddle 304. A reactor 302 may contain a plurality of mixing regions 322, delineated by at least one baffle 308 within the reaction chamber 320. Mixing of the biodiesel reaction mixture may be facilitated by a degree of turbulence in the mixing regions 322. Flow meters may be disposed at inlets to and outlets from the reactor to monitor and control the flow of material in an out of the reactor. The biodiesel reaction may proceed in multiple stages. After the first stage, the biodiesel reaction mixture may comprise at least one of biodiesel, an alcohol, unreacted triglycerides, unreacted catalyst, and glycerin. The biodiesel reaction mixture may then flow into a glycerin decanter.

With reference to FIG. 2, a plurality of decanters 212 or 218 may be employed. The decanters 212 or 218 may be of a similar or dissimilar design. In one embodiment, a decanter 212, or settling tank, may use gravity, allowing glycerin 224 to settle at a measurable rate while the biodiesel reaction product 220 rises above the glycerin 224. Within the decanter there may be diffuser plates to reduce turbulence within the settling tank. In an embodiment, the diffuser may be any shape, such as conical, cylindrical, round, flat, elliptical, and the like. The diffuser may ensure that the velocity of incoming biodiesel reaction mixture may not disturb the settling process by diminishing stirring, currents, eddies, and the like. In an embodiment, the outgoing material may also cause disturbances in the settling tank so the biodiesel and glycerin outlets may be fitted with a diffuser plate. The diffuser plate may be a ring with holes to reduce the velocity of biodiesel and glycerin as they leave the decanter. There may also be baffles within the decanter to maintain the residence time. In embodiments, the pressure and temperature of the decanter 212 may be regulated to maintain the solubility of the glycerin and optimize settling. Regulation of pressure and temperature may ensure the most efficient glycerin/biodiesel separation. Quality control of the decanting step may comprise measuring the density of material within the decanter 212 and at the outlets for outflow of glycerin and biodiesel. The decanter 212 may optionally include a filter which may be a coalescing filter. After settling, glycerin may be removed from the bottom of the tank while biodiesel and other materials are removed from the top of the tank. A level transmitter may show the position of the interface, the level of the biodiesel in the decanter, the level of the glycerin, and the like. A density meter on the outflow may monitor the mass flow rate to determine when a biodiesel-glycerin interface has been reached so as to maintain separation of glycerin and biodiesel outflows. If the interface is reached, a valve may shut off outflow and allow glycerin and/or biodiesel to build up. The temperature in the decanter may be tightly controlled to control glycerin solubility. There may be sample point outlets dispersed along the tank in order to monitor the efficiency the settling and the position of the interface between glycerin and biodiesel.

In another embodiment, a decanter 212 may remove glycerin 224 by centrifugal force. Whether a decanter uses gravity or centrifugal force or some other mechanism for separating, retention times for the glycerin 224 may be short, about thirty minutes for the first stage decant, for example, or longer as in the second stage decant. Additionally, efficiency of glycerin 224 removal may be high, approaching 98% glycerin 224 removal during the first five minutes of the first decanting step.

The glycerin decanted in one or both of the glycerin decanters may be directed to a crude glycerin standpipe. A level transmitter in the decanter may indicate a level of glycerin, and when a particular level is reached, the glycerin may be directed to the glycerin standpipe. Similarly, the level transmitter may indicate a level of biodiesel, and when a particular level is reached, the biodiesel may be directed to a biodiesel reactor, a flash evaporation system, a distillation column, a biodiesel tank farm, and the like. The glycerin may be subject to flash evaporation, as further described herein, to remove excess alcohol after the first stage decanter and/or after the second stage decanter. The process of removing the alcohol by flash evaporation may generate undesirable levels of foam. Foam formation may be controlled by the addition of an anti-foam agent. Anti-foam agents may be added to the glycerin at any point before or during flash evaporation, such as as its settling out in the glycerin decanter, as its piped to the standpipe, as its directed to the flash evaporation tank, and the like. The amount of anti-foam agent added to the glycerin may be calculated by weight or volume or may be added as needed. One such anti-foam agent may be a heat transfer fluid, such as Therminol® 55. In an example of the energy efficiency of the process, in order to provide the heat for flash evaporation, the heat from the decanters may be used to heat the glycerin the flash evaporation tanks. The glycerin may be subjected to neutralization. Glycerin neutralization may be initiated by the addition of sulfuric acid. Sulfuric acid may break up the polymers of glycerin and allows the recovery of free fatty acids. Polymers of glycerin may form when the catalyst is active in the absence of methanol. Recovery of free fatty acids may be facilitated by the modification of pH. Separation of glycerin from biodiesel may increase the gel point of the glycerin, such as from 110° F. in the presence of biodiesel to 200° F. in the absence of biodiesel.

As depicted in FIG. 2, the biodiesel 228 that has been separated from glycerin 224 by-products in the first decanting step may be introduced into a second reactor 214, and may be combined with an inflow of at least additional alcohol and catalyst. This second stage biodiesel reaction, with its lower concentration of glycerin and long residence time, may encourage the reaction to continue to completion.

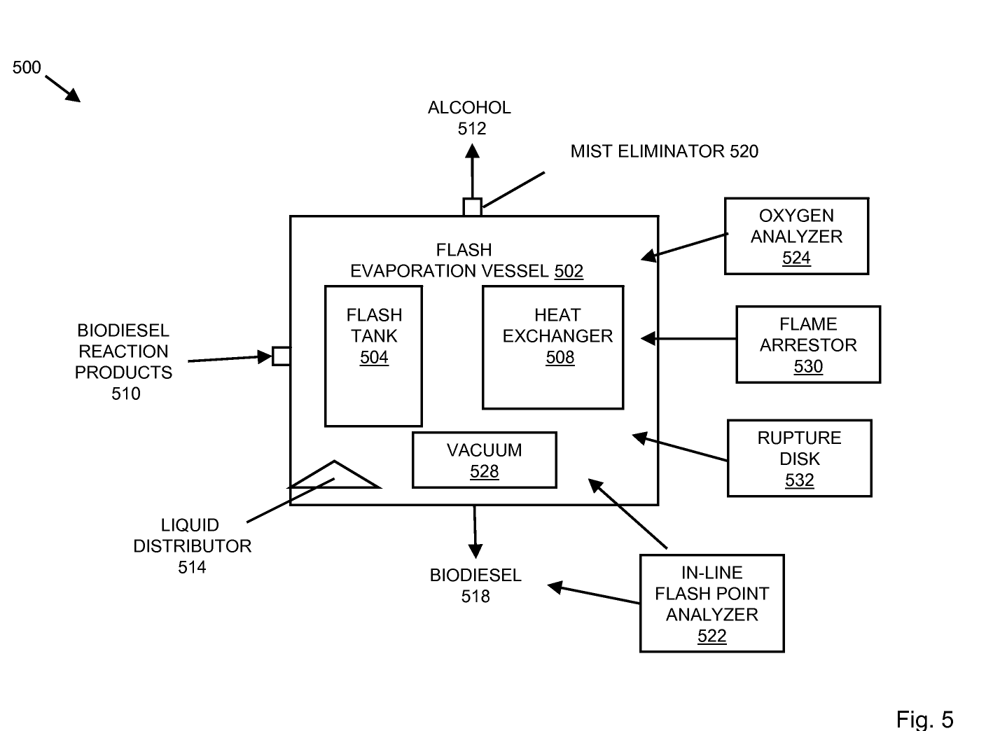

Referring now to FIG. 5, a flash evaporation system 500 may be useful for recovering alcohol 512 from the biodiesel reaction products 510. After the second stage reactor, the biodiesel reaction mixture may get sprayed into a flash tank both to reduce pressure in the system and to begin recovering alcohol from the biodiesel reaction mixture. This process results in relieved pressure which facilitates the recovery of alcohol. The alcohol is flashed off under high temperature and in a vacuum. This alcohol feeds into the alcohol recovery system for re-use. In an embodiment, the flash evaporation system 500 may be an Active Alcohol Recovery System. All of the vents from the biodiesel system may tie into an alcohol recovery system so that alcohol may be recaptured from any point along the process. The capture and reuse of alcohol may ensure that the plant has minimal alcohol emissions and may lower operating costs. The alcohol recovery system may comprise an alcohol reboiler, alcohol condenser, liquid ring vacuum pump, and the like. The liquid ring vacuum pump may vent to the alcohol condenser. The flash evaporation vessel 502 may comprise at least one flash tank 504 with at least one heat exchanger 508. In embodiments, the flash evaporation vessel 502 may comprise a plurality of flash tanks 504, for example, two or three. The design of the flash evaporation vessel 502 promotes the separation of liquid and vapor. A liquid distributor 514 inside the flash evaporation vessel 502 heats the alcohol 512 and promotes a phase change to a gas, while the biodiesel 518 remains a liquid. Once in its gaseous form, the alcohol 512 may be released from the top of the flash evaporation vessel 502 through a mist eliminator 520 while the liquid biodiesel 518 may flow from the bottom of the vessel. The pressure during this step may be reduced to 40 psi. The flash evaporation vessel 502 may act as a surge tank which allows for separation of the operation of the front end of the process (raw materials/reaction/glycerin side) from the tail end of the process (methanol recovery and biodiesel polishing). Before proceeding to the next step in the biodiesel process, the biodiesel may be further cooled. The hot biodiesel may pass through a heat exchanger with a cooling fluid on the other side of the heat exchanger, such as raw materials to be pre-heated for the first steps of the biodiesel process, or glycerin to be heated for flash evaporation, and the like. Generally, the biodiesel process is energy efficient in that heat from any point in the process may be captured, such as through use of a heat exchanger, to provide heat for any other step in the process.

In embodiments, the vigor of liquid distribution may be regulated. For example, if liquid distribution is too turbulent, biodiesel 518 may become entrained in the methanol vapor. If the distribution is not violent enough, the alcohol may not be able to fully vaporize and be drawn out of the process as a gas. An inline flash point analyzer 522 may measure the flash point of the biodiesel 518 as well as the temperature and vacuum of the flash evaporation vessel 502. Recovered alcohol 512 may be condensed and recycled as a biodiesel precursor raw material. In line with an alcohol condenser may be a non-condensable gas (NCG) condenser. The NCG condenser facilitates the removal of some non-condensable gasses to a degree which is sufficient to ensure that they do not interfere with the function of the alcohol condenser. The NCG condenser may decrease the pressure against which the alcohol condenser must work. The NCG condenser may facilitate setting up a vacuum in the flash tank to ensure the flow of alcohol in the tank does not go back out the way it entered the tank. The NCG and alcohol condensers may be monitored and the parameters of operation may be adjusted.

With reference to FIG. 5, there are a number of safety measures that may be employed with the flash evaporation system 500. The alcohol used in biodiesel production may be tightly contained and the facilities' emissions may be well below permit requirements. For example, oxygen analyzers 524 may ensure that the alcohol recovery system does not violate an explosion limit. A vacuum 528 may be used to guard against fugitive emissions. Flame arrestors 530 and rupture disks 532, which are modeled on turpentine handling systems for pulp mills, may also be used in the system. Further, lines may be sloped for condensate removal. As an end result, alcohol 512 may be collected, condensed and reused with trace alcohol being fired as vapor fuel for a hot oil boiler 608 and the biodiesel production unit, which also results in 99.9% or greater destruction of alcohol emissions.

After being subject to flash evaporation, the biodiesel reaction product 518 emerges from the flash evaporation vessel 502 with substantially less alcohol 512. The removal of the alcohol 512 results in a purer biodiesel 518 with a higher flash point. In addition, as a result of the flash evaporation process, the biodiesel reaction product 518 may be pre-heated prior to re-introducing it into the next steps of the biodiesel process.

In an embodiment, the biodiesel production unit may comprise flash tanks suitable for flash evaporation of materials from the second stage decanter, multiple stages of flash evaporation of glycerin, multiple stages of flash evaporation of biodiesel, and the like.

In an embodiment, the biodiesel may proceed to a second stage decanter to remove additional glycerin. The decanter 218 may allow for a long residence time to ensure complete removal of trace free glycerin 224. The decanting steps result in recovered glycerin 224 that may have multiple uses. For example, recovered glycerin 224 may be burned for power generation. Recovered glycerin 224 may be burned in a power boiler in order to produce a renewable electricity source. Recovered glycerin 224 may also be used as a de-icer, pulp mill chemical makeup, sodium makeup, pulp mill chemical (sodium) and fuel makeup, dust control, livestock feed, industrial cleaning product base, and base feedstock for the chemical and pharmaceutical industries.

Following the second stage decanter, the action of the catalyst may be terminated and the reaction quenched by addition of a catalyst kill agent 234. For example, a mild pH acid may prevent reversion of the methyl esters back into mono-, di-, and tri-glycerides. Catalyst kill may also prevent unwanted side reactions, such as soap production. Catalyst kill may also result in improved quality control as the reaction may be stopped at will. The catalyst kill agent 234 may comprise, for example and without limitation, solid, non-toxic, food grade anhydrous acid, such as citric acid, carbon dioxide, and the like. In an embodiment, the catalyst kill agent 234 may be added as a powder and dissolved into the biodiesel after glycerin separation. In an embodiment, the catalyst kill agent 234 may be added or injected as the biodiesel reaction mixture, biodiesel, or glycerin are directed to the flash recovery system. Catalyst kill agent 234 may be mixed into the biodiesel reaction mixture, biodiesel, or glycerin using a static mixer. The amount of catalyst kill agent added may be metered. For example, carbon dioxide neutralizes glycerin, lowers the pH of glycerin, and lowers the amount of foaming.

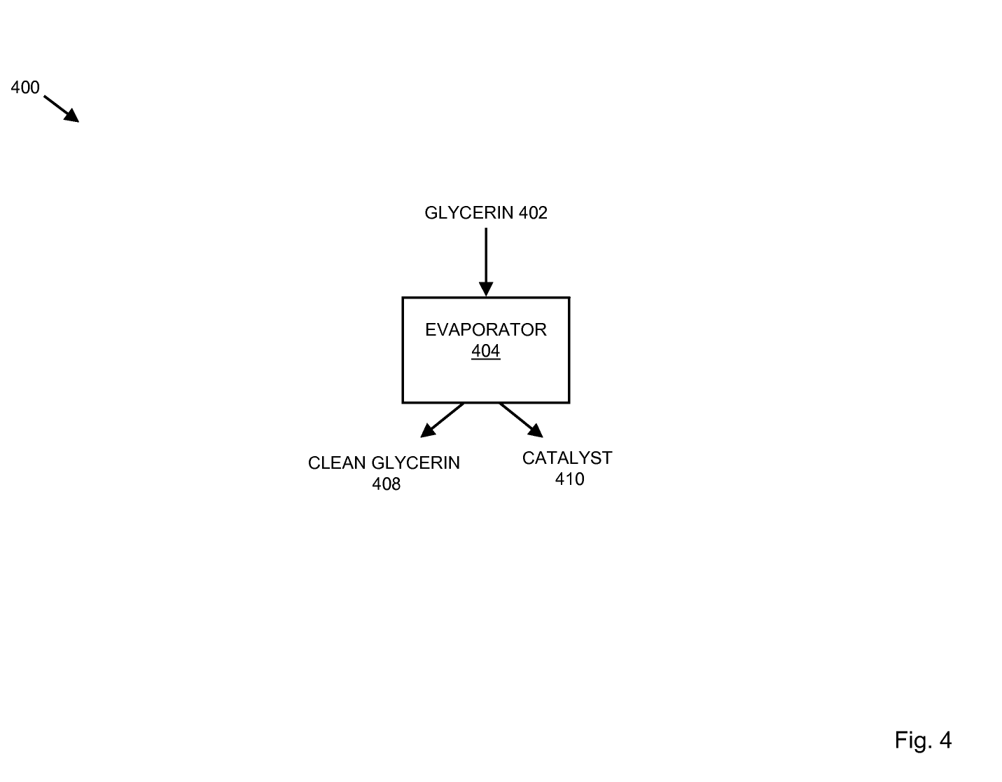

Referring now to FIG. 4, following catalyst kill, the suspended catalyst 410 may be recovered from the glycerin 402 using an evaporator 404. Suitable evaporators may include a wiped film or thin film evaporator, such as the Artisan system. For example, if the catalyst 410 is sodium methylate, the evaporator 404 may eliminate the sodium content resulting in clean glycerin 408 and regenerated sodium methylate that can be recycled as catalyst 410, optionally for successive iterations of the biodiesel process.

In an embodiment, following the second stage decanter, the biodiesel may be subject to another round of flash evaporation. In an embodiment, there may be multiple stages of flash evaporation. The flash evaporation tanks may be heated with recaptured heat from the process, such as heat from the distillation column, heat from the industrial fraction of the distillation column, heat from the automotive fraction of the distillation column, heat from the hot oil boiler, heat from the decanters, and the like.

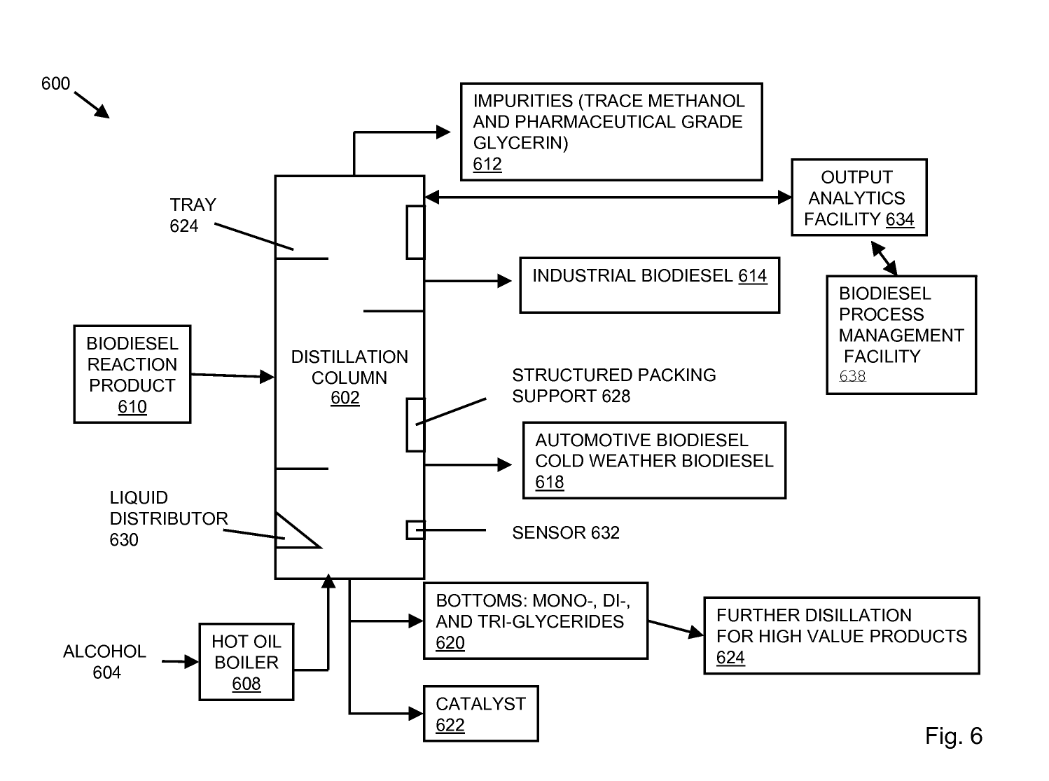

Referring now to FIG. 6, the vast majority of the recovered alcohol 604 may be condensed (over 98.5%) for recycling. A cooling tower, that may be similar to a swamp cooler, may condense the alcohol and cool the biodiesel process. Either condensed or not, is the alcohol may be fed into a hot oil boiler as fuel (7-10% of the heat load of the hot oil boiler). The hot oil boiler 608 may be useful for creating steam to heat a distillation column 602 for further biodiesel processing or other components of the biodiesel production unit, such as for providing heat upon start-up from the system when there may not be any waste heat for recovery yet, for shutdown, for freeze protection, and the like. The hot oil boiler 608 may be 99.9% efficient at alcohol destruction.

FIG. 6 depicts a system for biodiesel polishing 600 that is useful in the biodiesel production system described above. Biodiesel polishing involves the distillation of biodiesel reaction products 610 to remove impurities 612, industrial biodiesel 614, automotive biodiesel 614, bottoms 620, and catalyst 622. In embodiments, biodiesel polishing may also involve further distillation of bottoms 624 to obtain high value products. According to these systems and methods, the parameters for biodiesel polishing may be regulated by a biodiesel product management facility 152.

Referring now to FIG. 6 and in more detail, a distillation column 602 may be useful for separating biodiesel reaction products 610 into a plurality of biodiesels 614 or 618 and removing trace impurities 612, bottoms 620, and catalyst 622, a process also known as biodiesel polishing. The biodiesel polishing process may also contribute to feedstock flexibility. For example, the feedstock may be switched from palm oil to soybean oil, or any combination of the two, and the system may automatically compensate via the distillation process. In an example, using canola oil as a feedstock may result in distillation of an automotive biodiesel predominantly while other feedstocks may result in distillate that may need to be fractionated to obtain industrial biodiesel, automotive biodiesel, and the like. As shown in this Figure, a distillation column 602 performs certain product separations as part of the polishing process. In embodiments, the distillation column 602 may have a number of trays 624, structured packing support 628, and liquid distributors 630. Distillation may comprise heating the biodiesel reaction product 610 such that the distillation column trays 624 spill over as vapors rise and liquids fall. The temperature of the biodiesel entering the distillation column may be 400° F. Distillation output and efficiency may be affected by the operating pressure, operating temperature, reflux, the placement of liquid distributors 630 and mist eliminators, the number of theoretical plates, column packing surface area, and the like. The distillation column 602 may further comprise a sensor system 632 for identifying reaction parameters in the distillation column 602.

In an embodiment, the distillation column 602 may be associated with a distillation column reboiler. In an embodiment, the reboiler may be a shell and tube heat exchanger or other heat exchanger. Hot oil may pass through the tube and the biodiesel, either from the biodiesel reaction product or previously collected biodiesel, may pass through the shell. As the biodiesel passes over the tubes containing the hot oil, the biodiesel is heated enough to vaporize it. The vapors get injected, such as through liquid distribution spray nozzles, into the distillation column 602 and the vapors rise up through the packing of the column 602. There may be a large vent associated with the distillation column 602 to maintain the pressure drop in the column and keep the vacuum as high as possible.

In an embodiment, the distillation column 602 may be a split column design. The column 602 may be stainless steel with column packing on either side of a central divider. The biodiesel reaction product may enter the column 602 in the bottom portion of the column 602 so as not to contaminate the packing with impurities. After collection, the now purer biodiesel may be directed to a reboiler after which the biodiesel is sprayed down onto the packing from the top of the column. The bottom of the column 602 may have a basin to catch impurities not distilled.

As shown in FIG. 6, a distillation column 602 used in biodiesel polishing may receive a single biodiesel reaction product input 610 and may separate and collect a plurality of distinct outputs. The various outputs may be separated by boiling points. As the biodiesel reaction mixture 610 is heated, the most volatile components rise through the distillation column 602 as vapors. As the vapors rise, they may cool and undergo condensation on the walls of the distillation column 602 and the packing material 628. This condensate may continue to be heated by subsequent rising hot vapors and may vaporize once more. Each vaporization-condensation cycle, also known as a theoretical plate, may yield a purer solution of the more volatile component The “lightest” products (those with the lowest boiling point) may exit from the top of the columns and the “heaviest” products (those with the highest boiling point) may exit from the bottom of the column. In order to skew the production of heavier versus lighter biodiesel, distillation parameters may be regulated. In addition, feedstock oils with shorter or longer carbon chain lengths may be used to further skew the distribution of heavier versus lighter biodiesel. The material that comes off the top of the distillation column may require heated storage and handling.

In another embodiment, the distillation column 602 may use reflux to achieve a more complete separation of products that may be collected at various points along the length of the distillation column 602, such as through a liquid collector. Overhead vapors from the top of the column may be condensed in a reflux condenser and a product condenser maintained under vacuum with a liquid ring vacuum pump discharging to a noncondensable gas system. The lightest products separated from the biodiesel reaction product 610 and exiting the top of the column 602 as a distinct output stream may be trace alcohol and pharmaceutical grade glycerin impurities 612. The next lightest products exiting the column as a distinct stream may be a plurality of biodiesels segregated by boiling point or volatility. For example, industrial biodiesel 614 may exit the column 602 below the most volatile components. Industrial biodiesel 614 may be useful in warm weather environments or where heated storage tanks are available, but may not be suitable for cold weather use due to its 60° F. or higher gel point. Automotive and cold-weather biodiesels 618 may exit the distillation column 602 as a distinct output stream below industrial biodiesel 614 in the distillation column 602. Automotive biodiesel 618, for example, may have a gel point of less than 35° F. For biodiesels, the carbon chain length and number of double bonds may contribute substantially to the gel point determination. Longer carbon chains and fewer carbon double bonds result in higher gel points. In other words, the more double bonds an oil molecule has (i.e. the more “unsaturated” it is), the lower its gel point and the better suited it is for making biodiesel. For example, an increase in the amount of unsaturated molecules is required to get more automotive and less industrial biodiesel out of the feedstock. Saturated oils contain carbon atoms that are each bonded to two hydrogen atoms. These carbons cannot form double bonds to one another. Saturated oils do not resist gelling as well as unsaturated oils and are not as well suited for making biodiesel. Cold temperature issues with biodiesel therefore may arise when there are more saturated long-chain carbons. As an example, palm oil, with its 40° F. gel point, may be the feedstock oil for producing certain cold weather biodiesels. In embodiments, once a distillate is collected, the distillate may be cooled and subjected to another cycle of heating in the distillation column reboiler and distillation in the distillation column 602. A level transmitter in a collection tank may indicate a level of biodiesel in the collection tank, and when a particular level is reached, the biodiesel may be directed to a biodiesel tank farm.

In embodiments, the heaviest output, also known as ‘bottoms’ 620, may exit the distillation column 602 at the bottom of the stack as a distinct output stream. Bottoms 620 may include mono-, di-, and tri-glycerides. Additionally, catalyst 622 may exit the distillation column 602 at substantially the same position as the bottoms 620. In embodiments, bottoms 620 may be fired as fuel for subsequent iterations of the biodiesel production process or may be further distilled 624 to obtain value-added by-products, such as tocopherols (e.g.: vitamin E) and, long chain complex molecules that differ from methyl esters. Bottoms 620 and catalyst 622 may also be used to increase yield by being recycled back to the reactor as biodiesel precursor raw material.

In embodiments, biodiesel distillation may relate to recovery and removal of volatile components present in the biodiesel reaction product. In an embodiment, a distillation column 602 used in biodiesel polishing may receive a biodiesel reaction product input 610 and may separate and collect a plurality of distinct outputs, including but not limited to biodiesel products, alcohol, free glycerin, glycerol, tocopherols and sterol glucosides. The benefits of distilling the biodiesel product may include obtaining a relatively pure biodiesel product; the ability to grade tailor by distillation such as to obtain marine fuel, automotive fuel, cold weather fuel, and the like; the recovery of valuable tocopherols; the removal of filter clogging sterol glucosides; the removal and recovery of alcohol; and the like. Stabilizers, such as synthetic and natural stabilizers described further herein, may optionally be added back to the biodiesel product to enhance and/or adjust the biodiesel's thermal, oxidative, or long term storage stability. Alcohol vapors may collected from the distillation column 602.

In an embodiment, distilling the biodiesel may result in the removal or diminishing of volatile components in the distillates, such as the removal or diminution of tocopherols or sterol glucosides. In an embodiment, some volatile components may be removed or recovered from the bottoms 620 during biodiesel distillation and they may be effectively removed from the biodiesel. In an example, the tocopherols (otherwise known as Vitamin E) may be removed or recovered from the bottoms 620 during the distillation process. Recovery of tocopherols during distillation may result in a biodiesel distillate of diminished thermal, oxidative, and/or long term storage stability. Biodiesel, being a mixture of methyl esters of feedstock fatty acids, may be more susceptible to oxidation than mineral diesel. In some embodiments, the lower oxidative stability of biodiesel may be caused by a higher level of unsaturation and possibly by a larger amount of dissolved oxygen than mineral diesel. One of the factors in the stability of biodiesel may be the delay of oxidation by the presence of certain components of the biodiesel, such as tocopherols, sterol glucosides, and the like. Thus, the absence of tocopherols or any other anti-oxidant component of the biodiesel may facilitate an increase in the rate of oxidative degradation. Oxidative degradation of biodiesel may cause a build-up of gums and acids in an engine or other facility burning biodiesel that may cause poor combustion, fuel-filter plugging and other problems such as deposits on injectors and pistons. In the example, biodiesel stabilizers of the synthetic variety, such as and without limitation Adesta (Novus), Baynox (Lanxess), and Ethanox (Albemarle); natural stabilizers such as Pyrogallol, Gallic Acid, Propyl Gallate, Catechol, Nordihydroguaiaretic acid, 2-t-butyl-4-methoxyphenol, 2,6-di-t-butyl-4-methoxyphenol, 2,6-di-t-butyl-4-methylphenol, and t-butyl hydroquinone; or any combination thereof may be added to the biodiesel distillate to enhance biodiesel product stability. In an embodiment, biodiesel stabilizers may be Free Radical Chain Termination Agents, Free Radical Decomposition Agents, Acid Scavengers, Photochemical Stabilizers, Metal Sequestering Agents, and the like. Biodiesel stabilizers may have the ability to reduce the level of oxidation. In an example, biodiesel stabilizers may reduce the level of oxidation by trapping the free radicals that lead to the development of gums. Biodiesel stabilizers may be added at any point before, during or after the biodiesel distillation process. For example, biodiesel stabilizers may be mixed with biodiesel product as it emerges from the distillation column 602. Alternatively, biodiesel stabilizers may be mixed with biodiesel product in storage tanks, during transport, or at an end-use facility. Biodiesel stabilizers may be continuously or batch blended into the biodiesel as a concentrate or as a stock solution. In an embodiment, the biodiesel output analytics and management facility 634 may determine an appropriate amount of biodiesel stabilizer to add to a batch of distilled biodiesel or a batch of biodiesel reaction product being distilled. In an alternative embodiment, the biodiesel output analytics and management facility 634 may determine an appropriate amount of biodiesel stabilizer to add continuously during distillation or during outflow of biodiesel products to storage or transport.

In an embodiment, recovery of tocopherols from the biodiesel product may be a value-added process step. Tocopherol, also known as Vitamin E, is a valuable by-product of the biodiesel process, useful in human and animal supplements. Recovery of tocopherols during distillation may be subsequently followed by a purification or enrichment step to remove any impurities from the tocopherols fraction.

In another example, sterol glucosides may also be removed or diminished during biodiesel distillation. Sterol glucosides may occur naturally in vegetable oils, mainly as soluble fatty acid esters. During the biodiesel process, sterol glucosides may be hydrolyzed, which reduces their solubility. The crystallization, flocculation, and/or agglomeration of sterol glucosides may increase their potential for filter plugging. Even low levels of sterol glucosides (i.e., 10-90 ppm) in biodiesel product may form flocculants, precipitants, or aggregates with fatty acid methyl esters that may appear as a visible cloud or haze. These aggregates may accelerate filter plugging at any temperature, not just cold temperatures, due to the high melting point of sterol glucosides (i.e., 240° C.). At room temperatures, the sterol glucosides may aggregate and plug filters used for biodiesel fuel. At cold temperatures, the cold-flow problems caused by alkyl esters of saturated fatty acids such as monoacylglycerols may be compounded by the presence of the sterol glucosides.

The filter plugging tendency of the biodiesel product may be measured using the ASTM D 2068 test method. ASTM D 2068 is a test method that is intended for use in evaluating distillate fuel cleanliness in those applications that demand a high throughput per installed filter. A change in filtration performance after storage or pretreatment can be indicative of changes in fuel condition. Causes of poor filterability might include fuel degradation products, contaminants picked up during storage or transfer, or interaction of the fuel with the filter media. Any of these could correlate with orifice or filter system plugging, or both. In the test, a sample of the fuel to be tested is passed at a constant rate of flow, such as at 20 mL/min, through a glass fiber filter medium. The pressure drop across the filter is monitored during the passage of a fixed volume of test fuel. If a prescribed maximum pressure drop is reached before the total volume of fuel is filtered, the actual volume of fuel filtered at the time of maximum pressure drop is recorded. In an embodiment, the biodiesel output analytics facility 634 may perform the ASTM D 2068 method. The biodiesel fails the test if the maximum pressure is reached before the total volume of biodiesel is filtered. The biodiesel passes the test if the total volume of biodiesel is filtered before reaching the maximum pressure. In an embodiment, if the biodiesel fails the test, the biodiesel may be rerouted to the distillation column 602 by the biodiesel output analytics and management facility 634 for additional biodiesel polishing. In an embodiment, this cycle may be repeated until the biodiesel passes the test or until reaching an acceptable level of sterol glucosides. Alternatively, the amount of sterol glucosides remaining in the biodiesel product may be determined by any suitable analytical means, such as particulate measurement.

As shown in FIG. 6, the distillation column 602 may comprise a biodiesel output analytics and management facility 634 for analyzing characteristics of each biodiesel 614 or 618 in the plurality of biodiesels, either before, during or after the addition of biodiesel stabilizers. The biodiesel output analytics facility 634 may perform any of a number of analyses on a particular biodiesel, including gas chromatography, infrared spectroscopy, flash point analysis, water content analysis, sediment analysis, kinematic viscosity analysis, sulfur content analysis, copper strip corrosion analysis, cetane number analysis, cloud point analysis, conradson carbon residue analysis, distillation temperature analysis, lubricity analysis, microbial analysis, pH analysis, temperature analysis, filter plugging tendency analysis, and the like. The biodiesel output analytics facility 634 may provide operational feedback to the biodiesel process management facility 638. Based on the operational feedback, the biodiesel process management facility 638 may adjust reaction parameters for subsequent iterations, including the regulation of temperature, reaction duration, raw material quantity, raw material type, stir speed, order and speed of raw material addition. The biodiesel output analytics facility 634 may determine a downstream processing protocol for an output product such as a biodiesel, a biodiesel blend, a by-product, a recovered raw material, or the like. Such a downstream processing protocol may include techniques like separation, blending, additive addition, recycling, disposal, utilization, distillation, purification, further reaction, and the like. For example, the biodiesel product may first be analyzed by the biodiesel output analytics and management facility 634 to determine the amount of an additive, such as a biodiesel stabilizer, to add back to the biodiesel product given the amount of tocopoherol removed from the biodiesel product.

Since a plurality of biodiesels may be separated and collected in the distillation column 602, customized biodiesel fuels for various applications may be produced. In some embodiments, customized biodiesel fuels may be produced, separated, and/or collected based on a boiling point. Additionally, in certain embodiments, the distillation column 602 may distill biodiesel reaction product 610 derived from a variety of feedstocks or produced by another facility. The distillation column 602 may operate continuously or discontinuously. In embodiments, the distillation column 602 may avoid the use of water washes or an absorbent polishing agent, such as magnesium silicate, in its distillation of biodiesel reaction product 610, thereby avoiding the problems associated with direct contact, methanol-contaminated wastewater and spent magnesium silicate. However, in embodiments, the distillation column 602 may be used to carry out distillations in the presence of water washes and/or magnesium silicate or some other adsorbent. The distillation column 602 may advantageously produce a consistent biodiesel product with tightly controlled free and total glycerin that exceeds ASTM and BQ-9000 specifications, with biodiesel temperature properties (e.g., gel point) that are consistent and where automotive grade fuel may be better suited for cold-weather use.

In another embodiment, customized biodiesel products 142 may be produced according to these systems and methods by modifying the biodiesel production process or blending the biodiesel product with another component or additive 148. Custom biodiesel products 142 may be produced based on specific customer needs. For example, a custom biodiesel product 142 with a higher alcohol content may be more satisfactory as camp stove fuel than native biodiesel, because this latter product has too high a flash point. Such a blend may be achieved by addition of alcohol to the purified biodiesel 138 or by collecting incompletely purified biodiesel. Other possible applications of custom biodiesel products 142 include lighter fluids, cleaner burning marine fuels, locomotive fuels, truck fuels, highway fleet fuels, lubricants, and the like.

Climate or temperature specific designer blends may be enabled by the present invention. Biodiesel cutting may be based on specific temperature points. For example, the use of palm oil as a feedstock oil for the production of biodiesel suitable for cold weather applications is consistent with these systems and methods. Use of a custom biodiesel product 142 produced by these systems and methods and in underground applications may be advantageous because of the low level of emissions of Polycyclic Aromatic Hydrocarbons (PAHs), CO, and CO₂. For this reason, a custom biodiesel product 142 may be used for other poorly-ventilated environments, including ship holds, warehouses, factories, mines, and the like. Additionally, use of biodiesel in underground pipe applications may be advantageous because its low toxicity and high rate of biodegradation mean that leaks are non-issues compared to petroleum based fuels.

Custom biodiesel products 142 may also be useful for reducing NOx for the power industry. The biodiesel output analytics and management facility may measure NOx emissions from a plurality of biodiesel output streams and a biodiesel may be selectively chosen to permit low NOx emissions. Modification of biodiesel to reduce NOx emissions may be useful and may replace stack scrubbers required of power generators.

As described above, biodiesel may be blended with different additives 148 for various applications. For example and without limitation, a cold temperature biodiesel blend may be prepared by combining biodiesel with petroleum products such as kerosene, regular diesel, or by adding additives 148 employed for the enhancement of petrodiesel. Additives 148 may also be used in biodiesel to increase its oxidative stability, such as BHT, BHA, PBHQ, PG, and the like. In embodiments, biodiesel may be used as an additive in petroleum diesel blends to increase its lubricity. For example, a 2% biodiesel blend with Ultra-Low Sulfur Diesel (ULSD) may be sufficient to increase its lubricity

The biodiesel product may be handled by a biodiesel product handling facility 144 A biodiesel product handling facility 144 may comprise a product management facility 154, a storage system 158 and a product outflow system 160; and a byproducts handling facility 162, comprising a byproducts recycling and utilization facility, a byproducts disposal facility, and a byproducts storage system. The product management facility 144 may store information related to supply, demand, customer orders, transportation needs to deliver customer orders, and the like. The storage system 158 may include storage tanks, storage tank heaters, temperature monitors, microbial monitors, a sampling inlet to monitor biodiesel quality and oxidative stability during storage, and the like. Custom biodiesel products 142 may require separate storage tanks. The product outflow system 160 may comprise an outflow pipe from a distillation column to a storage tank, an outflow pipe from the storage tank to a transport vessel, and the like. A byproducts handling facility 162 may provide instructions directions to the system for recycling, disposing, using, or storing byproducts. For example, the byproducts recycling and utilization facility may direct the system to recycle 90% of the recovered methanol back to the biodiesel reactor while using the remaining 10% as fuel for the distillation column's hot oil boiler. In another example, the byproducts disposal facility may direct the system to dispose spent catalyst. In yet another example, the byproducts storage system may direct the system to store 100% of the recovered glycerin. Handling of the biodiesel may be accomplished either continuously or in batch mode.

All of the elements associated with biodiesel production may be contained within a single housing. Alternatively, the elements associated with biodiesel production may be stand alone elements in separate housings. Additionally, the biodiesel production unit may be sized to permit portability. Portability may comprise transporting and/or utilizing the production unit on a train, ship, truck, plane, and the like.

Transport of biodiesel to the end-user without the biodiesel's reaching its gel point may be facilitated by heating transport systems, storage systems and vessels. For example, biodiesel may be loaded onto barges at 250° F. in insulated tanks. Additionally, the tanks may be heated. In order to remove the biodiesel from the ship, the whole product retrieval system may be heated. Unlike ethanol, biodiesel may be able to be transported through the prior existing petroleum pipeline infrastructure. The value of this compatibility with the petroleum industry cannot be understated and opens up a major distribution channel in addition to barges and rail. Biodiesel may be loaded onto barges at, for example, 150° F. from heated, insulated tanks. While a loss of temperature while in transit is unavoidable, the high temperature loading capabilities at the biodiesel production facility may facilitate completion of most barge voyages without having to reheat the biodiesel prior to off-load. Transport barges may have installed cargo heating systems, double hulls, and the like.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A process for producing a biodiesel, comprising:
reacting a feedstock oil, alcohol and catalyst to form a mixture of biodiesel reaction product and byproducts;
quenching the reaction by adding a catalyst kill agent;
decanting the mixture to separate biodiesel reaction product from byproducts, the byproducts comprising glycerin and excess alcohol;
distilling the biodiesel reaction product in a distillation column to separate biodiesel from the biodiesel reaction product, recover tocopherols, and remove sterol glucosides from the biodiesel; and
adding a biodiesel stabilizer to the biodiesel.

2. The process of claim 1, further comprising subjecting the biodiesel to a test of filter plugging tendency, comprising:
passing a sample of the biodiesel at a constant rate of flow through a glass fiber filter medium;
monitoring the pressure drop across the filter during the passage of a fixed volume of the biodiesel;
determining if a prescribed maximum pressure drop is reached before the total volume of biodiesel is filtered; and
recording the actual volume of fuel filtered at the time of maximum pressure drop.

3. The process of claim 2, wherein the biodiesel fails the test if the maximum pressure is reached before the total volume of biodiesel is filtered.

4. The process of claim 3, further comprising re-distilling the biodiesel if the biodiesel does not pass the filter plugging tendency test.

5. The process of claim 2, wherein the biodiesel passes the test if the total volume of biodiesel is filtered before reaching the maximum pressure.

6-7. (canceled)

8. A process for producing a biodiesel, comprising:
distilling a biodiesel reaction product to remove tocopherols and sterol glucosides; and
adding biodiesel stabilizers to the resultant biodiesel to enhance thermal stability.

9. The process of claim 8, wherein the biodiesel has significantly fewer emissions than petroleum-based diesel when burned.

10. The process of claim 8, wherein the biodiesel is grade tailored by distillation.

11. The process of claim 8, wherein the tocopherols are recovered as valuable by-products.

12. The process of claim 8, wherein the biodiesel exhibits reduced filter clogging tendency.

13-28. (canceled)

29. A biodiesel reactor comprising:
a housing enclosing a chamber for reaction of biodiesel precursor raw materials; an inlet in the housing for inflow of the raw materials;
a stir bar anchored to an inner aspect of the housing bearing a plurality of stir paddles extending outwardly;
at least one baffle partially segmenting the chamber into a plurality of mixing regions; and
an outlet for outflow of reaction mixture.

30. The reactor of claim 29, wherein the stir bar is anchored centrally within the housing.

31. The reactor of claim 29, wherein the stir bar is oriented vertically within the housing.

32. The reactor of claim 29, wherein the stir paddles are attached to the stir bar at substantially right angles.

33. The reactor of claim 29, wherein the baffles are attached to the housing at an angle that is the same as the angle at which the stir paddles are attached to the stir bar.

34. The reactor of claim 29, further comprising a pressure and temperature controller.

35. The reactor of claim 29, wherein the inlet is adapted for an inflow of a plurality of feedstocks.

36. The reactor of claim 29, wherein the biodiesel precursor raw materials comprise a feedstock oil, an alcohol, and a catalyst.

37. The reactor of claim 36, wherein the alcohol is selected from the group consisting of methanol, ethanol, propanol and butanol.

38. The reactor of claim 36, wherein the catalyst is selected from the group consisting of sodium methylate, sodium hydroxide, potassium hydroxide, sulfuric acid, and vanadium-based catalysts.

39-85. (canceled)
